(19) United States
(12) Patent Application Publication
(10) Pub. No.: US 2005/0274646 A1
(43) Pub. Date: Dec. 15, 2005

(54) Catalyst for hydroprocessing of Fischer-Tropsch products

(75) Inventors: Keith H. Lawson, Ponca City, OK (US); Kandaswamy Jothimurugesan, Ponca City, OK (US); Rafael L. Espinoza, Ponca City, OK (US)

Correspondence Address: DAVID W. WESTPHAL;CONOCOPHILLIPS COMPANY - I.P. Legal, P.O. BOX 1267, PONONCA CITY, OK, 74602-1267, US

(73) Assignee: ConocoPhillips Company, Houston, TX (US)

(21) Appl. No.: 10/866,884

(22) Filed: Jun. 14, 2004

(51) Int. Cl. C10G 47/04; B05D 3/02; B05D 1/18

(52) U.S. Cl. 208/111.3; 208/111.35; 427/372.2; 427/430.1

(57) ABSTRACT

The invention generally relates to methods for modifying a porous amorphous material comprising micropores to reduce its micropore volume and to form a support for a hydroprocessing catalyst, to methods of making said catalyst, as well as to methods for hydrocracking employing said hydroprocessing catalyst characterized by a lower selectivity towards undesirable gaseous hydrocarbon products. In one embodiment, the method for modifying the amorphous material comprises depositing an inorganic oxide or inorganic oxide precursor to the amorphous material; and treating the deposited amorphous material so as to reduce its micropore volume by at least about 5 percent, while its mean pore diameter is substantially unchanged or changed by not more than about 10 percent. Further embodiments include the amorphous material comprising silica-alumina, and the deposited inorganic oxide or inorganic oxide precursor comprising silicon.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD OF THE INVENTION

The present invention relates to catalysts and porous catalyst supports and more specifically to reducing the micropore volume of supported hydroprocessing catalysts.

### BACKGROUND OF THE INVENTION

Natural gas, found in deposits in the earth, is an abundant energy resource. For example, natural gas commonly serves as a fuel for heating, cooking, and power generation, among other things. The process of obtaining natural gas from an earth formation typically includes drilling a well into the formation. Wells that provide natural gas are often remote from locations with a demand for the consumption of the natural gas.

Thus, natural gas is conventionally transported large distances from the wellhead to commercial destinations in pipelines. This transportation presents technological challenges due in part to the large volume occupied by a gas. Because the volume of a gas is so much greater than the volume of a liquid containing the same number of gas molecules, the process of transporting natural gas typically includes chilling and/or pressurizing the natural gas in order to liquefy it. However, this contributes to the final cost of the natural gas.

Further, naturally occurring sources of crude oil used for liquid fuels such as gasoline and middle distillates have been decreasing, and supplies are not expected to meet demand in the coming years. Middle distillates typically include heating oil, jet fuel, diesel fuel, and kerosene. Fuels that are liquid under standard atmospheric conditions have the advantage that in addition to their value, they can be transported more easily in a pipeline than natural gas, since they do not require the energy, equipment, and expense required for liquefaction.

Thus, for all of the above-described reasons, there has been interest in developing technologies for converting natural gas to more readily transportable liquid fuels, i.e. to fuels that are liquid at standard temperatures and pressures. One method for converting natural gas to liquid fuels involves two sequential chemical transformations. In the first transformation, natural gas or methane, the major chemical component of natural gas, is reacted with oxygen and/or steam to form synthesis gas, which is a combination of carbon monoxide and hydrogen. In the second transformation, which is known as Fischer-Tropsch synthesis, carbon monoxide is reacted with hydrogen to form organic molecules containing mainly carbon and hydrogen. Those organic molecules containing carbon and hydrogen are known as hydrocarbons. In addition, other organic molecules containing oxygen in addition to carbon and hydrogen, which are known as oxygenates, can also be formed during the Fischer-Tropsch synthesis. Hydrocarbons comprising carbons having no ring formation are known as aliphatic hydrocarbons and are particularly desirable as the basis of synthetic diesel fuel.

Typically, the Fischer-Tropsch product stream contains hydrocarbons having a range of numbers of carbon atoms, and thus has a range of molecular weights. Therefore, the Fischer-Tropsch products produced by conversion of synthesis gas commonly contain a range of hydrocarbons including gases, liquids and waxes. Depending on the molecular weight product distribution, different Fischer-Tropsch product mixtures are ideally suited to different uses. For example, Fischer-Tropsch product mixtures containing liquids may be processed to yield gasoline, naphtha, diesel, and jet fuel, as well as heavier middle distillates. Hydrocarbon waxes may be subjected to an additional hydroprocessing step for conversion to a liquid and/or a gaseous hydrocarbon. Thus, in the production of a Fischer-Tropsch product stream for processing to a fuel, it is desirable to maximize the production of high value liquid hydrocarbons, such as hydrocarbons with at least 5 carbon atoms per hydrocarbon molecule (C₅₊ hydrocarbons).

The Fischer-Tropsch process is commonly facilitated by a catalyst. Catalysts desirably have the function of increasing the rate of a reaction without being consumed by the reaction. A feed containing carbon monoxide and hydrogen is typically contacted with a catalyst in a reaction zone that may include one or more reactors.

The catalyst may be contacted with synthesis gas in a variety of reaction zones that may include one or more reactors, either placed in series, in parallel or both. Common reactors include packed bed (also termed fixed bed) reactors and slurry bed reactors. Originally, the Fischer-Tropsch synthesis was carried out in packed bed reactors. These reactors have several drawbacks, such as temperature control, that can be overcome by gas-agitated slurry reactors or slurry bubble column reactors. Gas-agitated multiphase reactors comprising catalytic particles sometimes called “slurry reactors,” “ebullating bed reactors,” “slurry bed reactors” or “slurry bubble column reactors,” operate by suspending catalytic particles in liquid and feeding gas reactants into the bottom of the reactor through a gas distributor, which produces small gas bubbles. As the gas bubbles rise through the reactor, the reactants are absorbed into the liquid and diffuse to the catalyst where, depending on the catalyst system, they are typically converted to gaseous and liquid products. The gaseous products formed enter the gas bubbles and are collected at the top of the reactor. Liquid products are recovered from the suspending liquid by using different techniques like filtration, settling, hydrocyclones, magnetic techniques, etc. Some of the principal advantages of gas-agitated multiphase reactors or slurry bubble column reactors (SBCRs) for the exothermic Fischer-Tropsch synthesis are the very high heat transfer rates, and the ability to remove and add catalyst online. Sie and Krishna (Applied Catalysis A: General 1999, 186, p. 55), incorporated herein by reference in its entirety, give a history of the development of various Fischer-Tropsch reactors.

An additional processing step for Fischer-Tropsch products is hydrocracking the Fischer-Tropsch wax and/or hydroisomerization of a Fischer-Tropsch product fraction. Hydrocracking typically includes reacting the wax over hydrocracking catalysts to convert the wax to hydrocarbon gases and/or liquids; whereas hydroisomerization typically includes reacting the wax over hydroisomerization catalysts to convert the hydrocarbons in Fischer-Tropsch product fraction to more branched hydrocarbons. The majority of catalyst currently used for hydrocracking, as well as hydroisomerization, are bi-functional in nature, and typically comprises a hydro-dehydrogenation component (one or more catalytic metals) and a cracking component (typically an acid component). The hydro-dehydrogenation component may include one or more metals from Groups 8, 9 and 10 of the Periodic Table of elements (according to the New Notation IUPAC Form as illustrated in, for example, the CRC Handbook of Chemistry and Physics, 82nd Edition, 2001-2002; said reference being the standard herein and throughout) and/or a metal from Group 6 of the Periodic Table. A cracking component may include a crystalline aluminosilicate material (typically zeolites), an amorphous inorganic oxide (typically an amorphous silica-alumina material), or mixtures thereof.

Amorphous cracking components are well known in the art. Usually, such cracking components are a mix of silica and alumina, which may be silica-rich (for example, containing from 50 to 95% by weight silica), alumina-rich, or of equal proportions of silica and alumina. Conventional homogeneous amorphous silica alumina materials can be used, as can the heterogeneous dispersions of finely divided silica alumina in an alumina matrix, as described in U.S. Pat. Nos. 4,097,365 and 4,419,271.

The cracking component is used to support the dehydro-hydrogenation component of the hydroconversion catalyst. Contrary to crystalline aluminosilicate materials (such as zeolites) that typically have a narrow pore size distribution, amorphous materials used as hydroconversion catalyst supports typically have a wide range of pore sizes, with a typical mean pore size of about 2-150 nanometers (nm). The amorphous supports typically contain a distribution of micropores, which are pores with a diameter of 1.5 nm or less. Without wishing to be bound by this theory, the Applicants believe that the presence of such micropores has an adverse affect upon the performance (specifically the selectivity) of the supported catalyst in applications such as the hydroprocessing of Fischer-Tropsch products. For instance, the selectivity towards desirable hydrocracked hydrocarbon products boiling in gasoline, kerosene and/or diesel boiling ranges is typically reduced.

The selectivity to desired hydrocarbon products is typically reduced by at least one of the following mechanisms: selective end cracking and secondary cracking. Small pores have a limited amount of space through which bulky hydrocarbon molecules can diffuse; hence, only ends of the bulky hydrocarbon molecules can penetrate the micropores, one factor which can promote asymmetric cracking (selective end cracking) and produce methane and/or other light C2-C5 hydrocarbons. Additionally, bulky molecules penetrating small pores also have a slow diffusion rate to exit said pores, and may reside in these small pores for a longer period of time such that a secondary cracking event may take place (an event when a hydrocarbon molecule is cracked once to form two cracked products in a pore structure, and at least one of these cracked products is cracked again prior to exiting the pore structure). For instance, it is expected that the yield of a diesel from a wax hydrocracking unit decreases as the amount of the micropores in the support (or cracking component) of the hydrocracking catalyst increases. Larger pores are believed to allow better diffusion of large hydrocarbon molecules into pores and can promote a more symmetric cracking of the hydrocarbon molecules entering the pores. Thus, Applicants believe that the deliberate and selective closing of some or substantially all of the micropores in an amorphous support for a hydroprocessing catalyst may result in the corresponding supported catalyst to be more selective towards desirable products in hydroprocessing reactions, particularly in hydrocracking reactions.

Consequently, there is a need for an improved catalyst and support for use in hydroprocessing Fischer-Tropsch products. Other needs include a method for deliberately reducing the amount of micropores or reducing the micropore volume in a support for a hydroprocessing catalyst. Additional needs include an improved process for hydroprocessing of Fischer-Tropsch products into diesel.

### SUMMARY OF THE INVENTION

These and other needs in the art are addressed in one embodiment by a method for decreasing a volume of micropores in an amorphous material. It has been found that by using an improved preparation technique to make an amorphous material, a hydroconversion catalyst employing said material as a support have a desirable middle distillate selectivity and can produce a significantly reduced level of undesirable gaseous (C1-C4) by-products. For instance, the hydrocracking of hexadecane with a hydrocracking catalyst supported on said material prepared according to the improved preparation technique results in a reduced hexadecane selectivity index in the hydro-converted product, wherein the hexadecane selectivity index of a hydrocracking catalyst is defined herein as the C4/C12 molar ratio in hydrocracked product achieved from converting about 40% normal hexadecane. As used herein, to “hydrocrack” means to divide an organic molecule into two molecular fragments and add hydrogen to the resulting molecular fragments to form two smaller hydrocarbons (e.g., C10H22+H2→C4H10 and skeletal isomers+C6H14 and skeletal isomers).

The method comprises providing an amorphous material having a volume of micropores, wherein the amorphous material comprises a mean pore diameter. It further comprises depositing an inorganic oxide or an inorganic oxide precursor to the amorphous material. Moreover, the method comprises treating said deposited amorphous material to form a modified amorphous material such that the modified amorphous material has a micropore volume at least 5 percent lower than that of the provided amorphous material, and wherein the modified amorphous material has a mean pore diameter differing by not more than 10 percent from that of the provided amorphous material.

Another embodiment comprises a method for making a hydroprocessing catalyst characterized by a low selectivity towards gaseous hydrocarbons. The method comprises providing an amorphous inorganic oxide material, wherein the amorphous inorganic oxide material comprises a volume of micropores, and wherein the amorphous inorganic oxide material further comprises a mean pore diameter. It further comprises depositing an inorganic oxide or an inorganic oxide precursor to the amorphous inorganic oxide material. Moreover, the method comprises treating said deposited amorphous inorganic oxide material to form an amorphous support such that the amorphous support has a micropore volume at least 5 percent lower than that of the amorphous material, and the amorphous support has a mean pore diameter differing by not more than 10 percent from that of the amorphous material. In addition, the method comprises depositing a compound of a catalytic metal to the amorphous support and treating the amorphous support comprising the deposited catalytic metal compound so as to form the catalyst.

Additional embodiments include the amorphous material comprising silica-alumina and the amorphous support comprising silica-alumina. Other embodiments include the amorphous material consisting essentially of silica-alumina and the amorphous support consisting essentially of silica-alumina. Further embodiments include the inorganic oxide or the inorganic oxide precursor comprising silicon; for example, the inorganic oxide may comprise an oxide of silicon, such as silica, or the inorganic oxide precursor may comprise a silicon-containing compound, such as an organic or inorganic salt of silicon, silicic acid, a silicate compound, or any combination of two or more thereof.

Another embodiment of the invention relates to a method for hydrocracking hydrocarbons with improved selectivity towards desirable products, said hydrocracking method comprising providing a hydrocracking catalyst, wherein the hydrocracking catalyst comprises a dehydro-hydrogenation component deposited on a modified porous amorphous support comprising a mean pore size between about 2 nm and 10 nm; and reacting a hydrocarbon stream with hydrogen over said hydrocracking catalyst under conversion promoting conditions so as to form hydrocracked products, wherein said modified porous amorphous support was made by a method comprising depositing a selective micropore filling compound to an amorphous material comprising pores of various pore sizes, including micropores with size of less than 1.5 nm and treating said deposited amorphous material so as to form said modified porous amorphous support, wherein the volume fraction of micropores in the modified amorphous support is lower by at least about 5% than that of the amorphous material, and further wherein the mean pore size of the modified amorphous support differs by not more than about 10% from that of amorphous material.

Additional embodiments include a method for hydrocracking hydrocarbons with improved selectivity towards desirable products. The method comprises providing a hydrocracking catalyst comprising a dehydro-hydrogenation component deposited on a modified porous amorphous support, wherein the modified porous amorphous support was made by a method comprising depositing a selective micropore filling agent to an amorphous material comprising pores of various pore sizes, including micropores with pore size of less than 1.5 nm, and treating the deposited amorphous material so as to form the modified porous amorphous support, wherein the volume fraction of micropores in the modified amorphous support is lower by at least about 5% than that of the amorphous material, and further wherein the mean pore size of the modified amorphous support differs by not more than about 10% from that of amorphous material. The method also comprises reacting a hydrocarbon stream with hydrogen over said hydrocracking catalyst under conversion promoting conditions so as to form a hydrocracked product.

Further embodiments include a method for hydrocracking hydrocarbons with reduced secondary cracking towards gaseous hydrocarbon products. The method comprises providing a hydrocracking catalyst, wherein the hydrocracking catalyst comprises a dehydro-hydrogenation component deposited on a porous amorphous silica-alumina support comprising a wide range distribution of pore sizes and a mean pore size between about 2 nm and 12 nm, and wherein the hydrocracking catalyst is characterized by a hexadecane selectivity index of less than 2.25. The method further comprises reacting a hydrocarbon stream with hydrogen over the hydrocracking catalyst under conversion promoting conditions so as to form a hydrocracked product.

It will therefore be seen that a technical advantage of the present invention includes reducing the volume of micropores in hydroprocessing catalyst supports, which overcomes problems with conventional supports for hydroprocessing catalysts. For instance, micropores tend to favor selective end cracking and/or secondary cracking of heavy hydrocarbons, which typically produces smaller cracked molecules that have less economic value than the heavy hydrocarbons. Larger pores allow better diffusion of bulky hydrocarbons. Most of the bulky hydrocarbon molecules can penetrate inside the larger pores and most of the carbon atoms along the chain length of the bulky hydrocarbon molecules have better access to a cracking site within the pores, which can result in a more symmetric (even) cracking.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which

FIG. 1 illustrates a comparative micropore analysis of conventional silica-alumina supports and silica-alumina supports impregnated with silicic acid;

FIGS. 2A and 2B illustrate comparative BHJ desorption analyses of conventional silica-alumina supports and silica-alumina supports impregnated with silicic acid; and

FIG. 3 illustrates the improved selectivity towards desired hydrocarbon products from hydrocracking n-hexadecane of a catalyst supported on a silica-alumina impregnated and treated with silicic acid compared to that of a catalyst supported on an untreated silica-alumina.

### DETAILED DESCRIPTION OF THE INVENTION

The present invention includes a method for reducing the volume of micropores in an amorphous material comprising a large distribution of pores, including micropores and mesopores. Micropores are defined as pores having a diameter of 1.5 nanometers (nm) or less. Mesopores are defined as pores having a diameter of greater than 1.5 nm and less than about 15 nm. In a preferred embodiment, the amorphous material is an amorphous, inorganic oxide, preferably an amorphous, inorganic oxide catalyst support. It has been discovered that deliberately decreasing the volume of micropores in the amorphous inorganic oxide support improves selectivity towards desirable products for hydroprocessing catalysts supported thereon, especially hydrocracking catalysts supported thereon. Without wishing to be limited by theory, it is believed that reducing the volume of micropores in the porous support favors a more symmetric (even) cracking of heavy hydrocarbon molecules, and as a result can reduce the formation of light undesirable hydrocarbons by minimizing end cracking and/or secondary cracking. It is also believed that increasing the volume fraction of mesopores in the support while reducing the volume fraction of micropores in the porous support promotes hydrocracking events to take place in more appropriately-sized pores, which can favor the formation of desirable hydrocracked products from heavy hydrocarbons.

In a preferred embodiment, the present invention includes a method for making an amorphous material having a reduced micropore volume comprising providing an amorphous material comprising a large distribution of pores including micropores; modifying the provided amorphous material by reducing the total micropore volume to form a modified amorphous material, so that the modified amorphous material has a micropore volume at least about 5% lower, preferably at least about 10% lower than that of the provided amorphous material.

The amorphous material can comprise an amorphous inorganic oxide material containing one cation such as (but not limited to) amorphous silica, alumina, titania, and the like; an inorganic oxide material containing a plurality of cations like an amorphous inorganic mixed oxide material, such as (but not limited to) amorphous silica-alumina, silica-titania, alumina-titania, or any mixture of two or more thereof. Amorphous inorganic oxide materials are well known in the art of catalysis, and examples of use as catalyst supports are plentiful. The amorphous inorganic oxide support of the present invention can comprise any suitable metal or metalloid oxide. The amorphous material preferably comprises a material such as titania, alumina, zirconia, silica, silica-alumina, silica-titania, and/or alumina-titania and/or mixtures thereof. More preferably, the amorphous material can be an amorphous silica, an amorphous alumina, or an amorphous silica-alumina. Still more preferably, the amorphous material comprises silica-alumina. Most preferably, the amorphous material comprises essentially an amorphous silica-alumina (i.e., more than 90 percent by weight).

The amorphous material can be purchased from suitable commercial sources, such as from Engelhard (Beachwood, Ohio); Sasol North America Inc (Houston, Tex.); Universal Oil Products or U.O.P. (Des Plaines, Ill.); Grace Davison (Columbia, Md.); Alcoa (Pittsburgh, Pa.); Saint-Gobain NorPro (Akron, Ohio); Criterion (Houston, Tex.); Zeolyst (Valley Forge, Pa.); or Akzo Nobel Inc. (Chicago, Ill.).

Alternatively, the amorphous material can be prepared by any method known to one of ordinary skill in the art. Examples of suitable methods include the sol-gel method, precipitation, reverse precipitation, co-precipitation, or any combination thereof. The method of preparation is not believed to be critical to the present invention, as long as the prepared amorphous material is porous with an average pore size of at least 2 nm (preferably between about 2 nm and 12 nm), and comprises some micropores. Preferred methods of preparation for amorphous materials employing precipitation are disclosed herein. In a preferred embodiment, the method comprises preparing a gel of the amorphous material; aging the gel for a suitable amount of time; and treating the gel to form the amorphous material. Preparing a gel of the amorphous material preferably includes dispersing one or more amorphous material precursors in a solvent in the presence of a precipitation initiator so as to initiate precipitation and to form a gel of said amorphous material. The method may further include washing the amorphous material gel after aging but before treating the gel. Any precipitation initiator known in the art can be used. Suitable precipitation initiators include acids such as nitric acid, acetic acid, hydrochloric acid, formic acid, or bases such as ammonia, ammonium hydroxide, tetrapropyl ammonium hydroxide (known as TPAOH) and sodium hydroxide.

When the amorphous material comprises silica-alumina, the method of making the amorphous silica-alumina material preferably comprises mixing a soluble aluminum-containing compound and a soluble silicon-containing compound in a suitable solvent in the presence of a precipitation initiator under conditions suitable for forming a silica-alumina gel; aging the silica-alumina gel under suitable aging conditions; washing the silica-alumina gel; and treating the silica-alumina gel. Suitable conditions for forming the gel include conditions sufficient for co-precipitation of aluminate and silicate ions from solution to form the alumino-silicate seed crystals, which serve as sites for the initiation of crystallization. Preferable conditions for forming the gel comprise a temperature between about 15° C. and about 90° C., an initial pH between about 5 and about 12, and a period of time between about 1 minute and about 6 hours. Suitable soluble aluminum-containing compounds for use in the present method are those capable of contributing aluminate (AlO₂⁻) ions to a silica-alumina matrix. Such compounds may directly contain aluminate ions, such as, for example, sodium aluminate; or may generate aluminate ions upon reaction, as for example from the hydrolysis of aluminum triisopropoxide (Al(iC₃H₇O)₃). Examples of suitable aluminum-containing compounds include aluminum triisopropoxide (Al(iC₃H₇O)₃), sodium aluminate (NaAlO₂), aluminum nitrate (Al(NO)₃), and aluminum hydroxide (Al(OH)₃). Sodium aluminate is a preferred aluminum-containing compound for preparing a low-acidity amorphous silica-alumina material, and aluminum hydroxide is a preferred aluminum-containing compound for preparing a high-acidity amorphous silica-alumina material. Suitable soluble silicon-containing compounds for use in the present method are those capable of contributing silicate (SiO₄⁴⁻) ions to a silica-alumina material. Such compounds may directly contain silicate ions, such as, for example, sodium silicate; or may generate silicate ions upon reaction, as for example from the hydrolysis of tetraethoxysilane. Examples of suitable silicon-containing compounds include tetraethoxysilane (Si(C₂H₅O)₄), silicic acid or sodium silicate (Na₄SiO₄). Sodium silicate is a preferred silicon-containing compound for use in the present method of preparing a low-acidity silica-alumina material, and silicic acid is a preferred silicon-containing compound for use in the present method of preparing a high-acidity silica-alumina material. Suitable solvents in which soluble aluminum- and silicon-containing compounds may be mixed in the current method include any of the common organic solvents as for example, acetone, ethanol, isopropanol, ether and the like; as well as inorganic solvents, as for example, water. Water is a preferred solvent for use in the present method of the invention.

In one embodiment, the method can employ a combination of two or more of any of the above silicon-containing sources, aluminum-containing sources and/or precipitation initiators.

Aging can be performed for a time between 0.5 hours and 18 days, depending on the amorphous material sources and the desired acidity. For a low-acidity silica-alumina gel, the aging is performed preferably at room or ambient temperature between 0.5 hours and 72 hours, and still more preferably between 1 hour and 24 hours. Preferably, for a high-acidity silica-alumina gel, the aging is performed first at room or ambient temperature between 3 days and 15 days, more preferably between 10 days and 14 days, and then at a temperature between 50° C. and 90° C., preferably at about 70° C., between 12 hours and 5 days, more preferably between 2 days and 4 days, still more preferably at about 3 days.

The method of preparing the amorphous material further comprises washing the aged gel with a wash liquid. The washing step can be effective to remove any unprecipitated amorphous material precursor molecules (such as the silicon and aluminum sources in a silica-alumina gel), and/or to exchange cations with protons. The wash liquid is preferably water. After the aging and the washing step, the gel of the amorphous material is then treated to form the amorphous material.

Treating the gel comprises drying and/or calcination. When treating the gel comprises drying, the gel can be dried under any suitable conditions readily understood by one of ordinary skill in the art. Preferably, the gel is dried under conditions sufficient to substantially remove all of the water present in the gel. The gel is preferably dried at a temperature between 80° C. and 150° C., more preferably between 110° C. and 130° C.; at a pressure between 0 atm and 10 atm (0-1,015 kPa), more preferably between about 1 atm and 5 atm (100-510 kPa), still more preferably at about 0.95-1.05 atm (95-105 kPa); and for between 1 and 48 hours, more preferably from 5 to 24 hours. The drying is preferably done in an atmosphere of air. The dried material described above can be used as a powder or can be formed into any desired shapes such as pills, cakes, extrudates, powders, granules, spheres, etc., and they may be utilized in any particular size.

Treating further comprises calcining the dried material for a period of time sufficient to transform silicate and aluminate species to silica-alumina, preferably at a temperature between 230° C. and 800° C., more preferably between about 400° C. and about 600° C., still more preferably between about 500° C. and 600° C.; at a pressure between 0 and 10 atm, more preferably between about 1 atm and 5 atm, still more preferably at about 1 atm; and between 0.5 and 24 hours, more preferably between 1 and 10 hours. The calcination preferably includes heating the gel in an oxidizing atmosphere, such as air or other suitable oxygen-containing gas.

Either after drying or calcining the amorphous material, but preferably after drying and before calcining, the amorphous material can be properly sized for its intended use in a hydroconversion unit, since the amorphous material serves as the basis for the support or carrier of the hydro-dehydrogenation component to form the hydroconversion catalyst. The dried or calcined amorphous material can be in the form of powder and used as is. The calcined amorphous material can be crushed and then passed through a sieve so as to collect particles of size greater than about 0.25 millimeter (mm), preferably between about 0.25 mm and about 3 mm, more preferably between about 1 mm and 2 mm. Alternatively, the dried or calcined amorphous material may be shaped into particles. A shaping step may include the mixing of the dried or calcined amorphous material with a binding agent or binder. However, it must be emphasized that the amorphous material may be made and successfully used without a binder. The binder, when employed, can comprise from about 0.1 to 50 mass- %, preferably from about 1 to 20 mass- %, preferably from about 2 to 10 mass- % of the finished support. Any refractory inorganic oxide binder can be suitable. One or more refractory inorganic oxides selected from among silica, alumina, silica-alumina, magnesia and mixtures thereof are suitable binder materials of the present invention. Examples of non-limiting suitable binders include alumina, silica, bentonite, kaolin, and any mixture of two or more thereof. A preferred binder material is alumina. The amorphous material and the optional binder can be mixed along with a peptizing agent such as hydrochloric acid (HCl), nitric acid (HNO3), potassium hydroxide (KOH), and the like to form a homogeneous mixture, which is formed into a desired shape by shaping means well known in the art. These shaping means include extrusion, spray drying, oil dropping, marumarizing, conical screw mixing, etc. Extrusion means include screw extruders and extrusion presses. The shaping means will determine how much water, if any, is added to the mixture. Thus, if extrusion is used, the mixture can be in the form of a dough, whereas if spray drying or oil dropping is used, then sufficient water is preferably present to form a slurry. The shaped particles may be in any suitable shape, for example spheres, cylinders, rings, symmetric or asymmetric polylobes, for instance tri- and quadrulobes, and trefoil or quatrefoil in cross-section. The desired particulate size depends on the type of catalyst bed in which the particulates are used. In preferred embodiments when the particulates of the hydroconversion catalyst support of the present invention are used in a fixed bed arrangement, the desired particulate size is greater than about 0.25 millimeters (mm), preferably between about 0.5 mm and about 3 mm, more preferably between about 1 mm and 2 mm, still more preferably between about 1.2 mm and 1.8 mm. Alternatively, when the particulates of the hydroconversion catalyst support of the present invention are used in a fluidized bed arrangement, the desired particulate size is typically less than about 0.25 mm. These shaped particles may be calcined after shaping, if a calcination is not performed prior to shaping and/or if a binder is employed during the shaping and some or all of the binder needs to be removed. Alternatively, the calcined material may be shaped into particulates, by crushing the non-shaped calcined material and sieving the crushed material for collecting particulates within a desired size range.

The method for reducing a volume of micropores in the provided amorphous material (whether purchased from a commercial source or prepared by a preferred method such as those described above) preferably comprises depositing an inorganic oxide or an inorganic oxide precursor to the amorphous material; and treating said deposited amorphous material to form a modified amorphous material, such that the modified amorphous material has a micropore volume (i.e., the pore volume of pores with a size of less than 1.5 nm) at least about 5 percent lower, preferably at least about 10 percent lower, more preferably at least about 20 percent lower than that of the provided amorphous material. Furthermore, the modified amorphous material can have a mean pore diameter differing by not more than about 10 percent, preferably by not more than about 5 percent, more preferably by not more than about 3 percent from that of the provided amorphous material. The mean pore diameter is defined herein as the mean diameter of all pores of any size in the amorphous material. Preferably, the inorganic oxide or the inorganic oxide precursor includes at least one inorganic element selected from among silicon, aluminum, titanium, zirconium, vanadium, yttrium, cerium, thorium, tungsten, and any mixture of two or more thereof. More preferably, the inorganic oxide or the inorganic oxide precursor comprises silicon. Still more preferably, the inorganic oxide comprises an oxide of silicon, or the inorganic oxide precursor comprises silicic acid. Most preferably, the inorganic oxide comprises essentially an oxide of silicon (i.e., greater than 95% by weight), or the inorganic oxide precursor comprises essentially silicic acid (i.e., greater than 95% by weight).

Preferably, the modified amorphous material serves as an amorphous inorganic oxide support for a hydroconversion catalyst. The amorphous inorganic oxide support having reduced micropore volume preferably comprises a total pore volume between about 0.1 ml/g and about 3 ml/g; more preferably between about 0.1 ml/g and about 2 ml/g; and most preferably between about 0.1 ml/g and about 1 ml/g. In addition, the amorphous inorganic oxide support can comprise a mean pore diameter greater than 2 nm, preferably between about 2 nm and about 12 nm, more preferably between about 3 nm and about 9 nm, still more preferably between about 4 nm and about 8 nm and most preferably between about 4 nm and about 6 nm. Moreover, the amorphous inorganic oxide support preferably comprises a surface area, as measured by the BET method, between about 100 m²/g and about 800 m²/g, more preferably between about 200 m²/g and about 600 m²/g.

The preferred amorphous support used as a cracking component for the hydroconversion catalyst according to the present invention comprises a silica-alumina material with a silica-to-alumina molar ratio between 3:1 and 500:1, preferably between 3:1 and 200:1, more preferably between 10:1 and 100:1, still more preferably between 20:1 and 100:1. In alternate embodiments, the silica-alumina material has a silica-to-alumina molar ratio between 3:1 and 50:1. The amorphous silica-alumina material in general has a surface area greater than 300 m²/g, preferably between 300 m²/g and 800 m²/g; a total pore volume between 0.2 ml/g and 1.5 ml/g, preferably between 0.3 ml/g and 1.0 ml/g. In addition, the amorphous silica-alumina material preferably comprises a mean pore diameter preferably between about 2 nm and about 12 nm, more preferably between about 3 nm and about 9 nm, still more preferably between about 4 nm, and about 8 nm and most preferably between about 4 nm and about 6 nm.

Reducing the total micropore volume in the amorphous material is preferably accomplished by impregnating a colloidal sol to the provided amorphous material, wherein the colloidal sol comprises the inorganic oxide or the inorganic oxide precursor; and treating the impregnated material to reduce its total micropore volume. It is to be understood that the present invention is applicable to amorphous materials having any pore size distribution. Without being limited by theory, it is believed that the total micropore volume is reduced by at least partially filling in at least a portion of the micropores. The total volume of micropores is reduced by at least 5 percent while the mean pore diameter is changed by not more than 10 percent.

The colloidal sol comprises any suitable material that is chemically inert, that is substantially stable under high heat and pressure such as that found in hydroprocessing reactions. Preferably, the colloidal sol comprises an inorganic oxide or inorganic oxide precursor, which includes at least one inorganic element selected from among silicon, aluminum, titanium, zirconium, vanadium, yttrium, cerium, thorium and tungsten. More preferably, the colloidal sol comprises silicon. Most preferably, the colloidal sol comprises silicic acid, when the provided amorphous material comprises silica-alumina. The colloidal sol comprises an amount of the inorganic oxide precursor or the inorganic oxide between about 0.5 wt. % and about 10 wt. % of the colloidal sol, more preferably between about 1 wt. % and about 6 wt. % of the colloidal sol, and most preferably between about 2 wt. % and about 4 wt. %. The colloidal sol comprising silicic acid can be prepared by passing a solution comprising at least one salt comprising silicon such as a silicate salt (sodium silicate, magnesium silicate, and/or aluminum silicate) through an ion-exchange resin to substitute the silicon counterions with protons so as to form silicic acid. The pH during ion-exchange on the ion-exchange resin is preferably between 2 and 3. The colloidal sol comprises between about 0.5 wt. % and about 5 wt. % silicic acid, more preferably between about 1 wt. % and about 4 wt. % silicic acid, and most preferably between about 2 wt. % and about 4 wt. % silicic acid. Alternatively, the colloidal sol comprising the inorganic oxide or the inorganic oxide precursor can be formed by precipitation of at least one inorganic oxide source (such as precipitation of a basic source with an acidic precipitation agent or precipitation of an acidic source with a basic precipitation agent).

Depositing at least one inorganic oxide or inorganic oxide precursor to the provided amorphous material comprises impregnating the colloidal sol or a solution to the amorphous material, wherein the colloidal sol or the solution includes said inorganic oxide or inorganic oxide precursor. The colloidal sol or solution can be impregnated by any suitable method such as incipient wetness impregnation (also called pore volume impregnation as it employs the deposition of a volume of solution or colloidal sol about equal to the pore volume), or impregnation utilizing a smaller volume of solution or colloidal sol than the pore volume, which is defined as “sub-pore volume impregnation.” For “sub-pore volume impregnation”, it is preferred that the volume of solution or colloidal sol applied to the amorphous material be between about 25% of the pore volume and 75% of the pore volume, preferably between about 40% of the pore volume and 60% of the pore volume. “Sub-pore volume impregnation” may be quite effective in reducing the micropore volume of the amorphous material, as Applicants believe that filling of the micropores compared to larger pores (such as mesopores) is favored. A “micropore volume impregnation,” which can employ the deposition of a volume of solution or sol about equal to the micropore volume of the amorphous material, can also be quite effective for the deposition step. Preferably, the solution or colloidal sol containing the micropore filling agent is impregnated by incipient wetness impregnation (i.e., pore volume impregnation) or “sub-pore volume impregnation”.

It is to be understood that impregnation can be done in a single step or multiple steps. The need for multiple impregnation steps can be dictated by several factors, such as the micropore volume that needs to be filled; the concentration of inorganic oxide or inorganic oxide precursor in the colloidal sol or solution that may affect the flowability and viscosity of the colloidal sol or solution. If a substantial reduction in micropore volume is desired, sequential impregnation steps may be performed until a desired micropore volume reduction is achieved. Additionally, a thick or viscous colloidal sol or solution may not penetrate the micropores as well as a thinner or less viscous colloidal sol or solution. For example, the Applicants found that, although a colloidal sol comprising 4% silicic acid can be used for the deposition step with acceptable micropore volume reduction of an amorphous silica-alumina material, the viscosity of the 4% silicic acid colloidal solution is such that it may not give optimal results for deposition by incipient wetness impregnation of silicic acid. Therefore, the viscosity of the colloidal sol or solution may need to be adjusted, for example can be reduced by lowering the content of the inorganic oxide or inorganic oxide precursor or by heating the colloidal sol or solution and performing the impregnation at a higher temperature (higher than ambient temperature). Although not wishing to be bound to this theory, Applicants hypothesize that the selective deposition in micropores of the inorganic oxide or inorganic oxide precursor (i.e., filling agent) may be due to the capillary-driven flow in these small pores.

Treating the impregnated amorphous material comprises drying and/or calcination. Drying conditions comprise any suitable conditions readily understood by one of ordinary skill in the art. Preferably, the drying conditions comprise conditions sufficient to substantially remove all of the water present. More preferably, the drying conditions comprise a temperature between about 80° C. and about 120° C. The time for drying is typically between about 8 hours and about 12 hours, but can be more or less, as the time necessary for the drying step can depend on the size of the equipment (e.g., oven, drier, and the like) and its load or feed rate.

Calcination conditions comprise any suitable conditions readily understood by one of ordinary skill in the art. Preferably, the calcination conditions comprise a temperature between about 400° C. and about 600° C. The time for calcining is typically between about 1 and about 4 hours, but can be shorter or greater, as the time necessary for the calcining step can depend on the size of the equipment (e.g., oven, drier, and the like) and its load or feed rate.

The amorphous inorganic oxide support having a reduced total volume of micropores can be used as support for hydroprocessing catalysts. The majority of hydroprocessing catalysts currently used for hydrocracking as well as hydroisomerization are bi-functional in nature. A hydroconversion catalyst typically comprises a hydro-dehydrogenation function (typically one or more catalytic metals from Groups 6, 7, or 8 of the Periodic Table based on the new IUPAC notation) and a cracking function (typically an acid component such as the catalyst support). More specifically, the hydroprocessing catalyst comprises a metal catalytically active to promote hydro-dehydrogenation during the hydrocracking of hydrocarbons. The hydro-dehydrogenation function may employ one or more metals from Groups 8, 9 and 10 of the Periodic Table of elements (according to the new IUPAC notation) such as iron, cobalt, nickel, ruthenium, rhodium, palladium, osmium, iridium, and platinum; preferably including a noble metal such as ruthenium (Ru), palladium (Pd), osmium (Os), and platinum (Pt). Alternatively, the hydro-dehydrogenation function may employ a combination of a Group 6 metal such as chromium (Cr), tungsten (W), or molybdenum (Mo), with a metal from Groups 8, 9, and 10 (typically a non-noble metal such as iron (Fe), cobalt (Co), nickel (Ni)), such as the following non-limiting combinations: Co—Mo, Co—W, Ni—Mo, Ni—W or Ni—Co—Mo. Preferably, the hydro-dehydrogenation component comprises platinum, palladium, nickel, cobalt, tungsten, and/or molybdenum. More preferably, the hydro-dehydrogenation component of hydroconversion catalysts comprises ruthenium, palladium, platinum, or combinations thereof. Still more preferably, the hydro-dehydrogenation component of hydroconversion catalyst comprises platinum and/or palladium, most preferably platinum. The hydroconversion catalyst preferably contains a catalytically effective amount of the catalytic metal. It is to be understood that the amount of catalytic metal present in the hydroconversion catalyst may vary widely. When the hydro-dehydrogenation component comprises a noble metal such as Pt or Pd, the hydroconversion catalyst preferably comprises from about 0.05 percent of the noble metal by weight (wt %) to about 2 wt % per total weight of the hydrocracking catalyst; more preferably from about 0.1 wt % to about 1 wt % of said noble metal; still more preferably from about 0.1 wt % to about 0.5 wt % of said noble metal. When the hydro-dehydrogenation component comprises a non-noble transition metal (such as Co, Ni, W, Mo) or any combination thereof, the hydrocracking catalyst preferably comprises from about 0.5 wt % to about 20 wt % of said non-noble transition metal; more preferably from about 1 wt % to about 15 wt % of said non-noble transition metal; still more preferably from about 2 wt % to about 15 wt % of said non-noble transition metal.

The hydroprocessing catalyst may further comprise a binder. The binder may comprise a zeolite material. In addition to the amorphous support having a reduced total micropore volume of the present invention serving as cracking component, a binder, in particular a refractory inorganic oxide binder or a zeolite, may also be incorporated into the catalyst composition in the process of the invention where necessary for example to assist with extrusion. Examples of suitable binders include alumina, silica, aluminum phosphate, magnesia, titania, zirconia, silica-alumina, silica-zirconia, silica-boria and combinations thereof. Alumina is the most preferred binder. It is also possible to use a material, which converts into a suitable binder material under the extrusion and calcining conditions of the process of the invention. Such suitable binder-forming materials include alumina hydrogels or silica-alumina co-gels. If present, the amorphous support of the present invention serving as cracking component can also act as binder for other cracking component(s), where necessary.

Another embodiment comprises making a hydroprocessing catalyst from the amorphous inorganic oxide support having a reduced total micropore volume. Preparing the hydroprocessing catalyst comprises depositing a hydro-dehydrogenation component such as a catalytic metal or a catalytic metal precursor to the amorphous inorganic oxide support of the present invention. The catalytic metal can be deposited by any suitable method such as impregnation, precipitation, ion exchange, chemical vapor deposition, or plasma sputtering. Preferred methods of deposition of a suitable hydro-dehydrogenation component include impregnation or ion exchange onto the cracking component (i.e., the amorphous inorganic oxide support of the present invention) with a solution containing at least one catalytic metal or catalytic metal precursor. The solution can include a solvent suitable for dissolving the catalytic metal or a precursor of said catalytic metal such as water and non-aqueous solvents (e.g., toluene, methanol, ethanol, and the like). One of ordinary skill in the art will be able to select the most suitable solvent for a given catalytic metal precursor or a catalytic metal. The deposited catalytic metal can be in the form of a salt or a zero-valent compound.

Thus, one method of preparing the hydrocracking catalyst is by incipient wetness impregnation of a solution of a soluble catalytic metal compound onto the cracking component (acting as a support). Incipient wetness impregnation preferably proceeds by dissolving a compound comprising one or more catalytic metals in a minimal amount of solvent sufficient to fill the pores of the amorphous inorganic oxide support of the present invention. Another method of catalytic metal deposition is to impregnate the amorphous inorganic oxide support of the present invention with a solution of zero-valent metal. It is to be understood that impregnation can be done in a single step or multiple steps. If the hydro-dehydrogenation component comprises more than one catalytic element, then the catalytic elements can be applied by co-impregnation (applied simultaneously onto the cracking component), or by successive impregnation steps.

When a catalytic metal precursor (e.g., a salt or zero-valent compound) is impregnated, one of ordinary skill in the art will be able to select the most suitable precursor. Impregnating catalytic metals to a support is well known in the art, and the catalytic metal(s) of the present invention can be impregnated on the support by any suitable method.

More particularly, according to the deposition method based on impregnation, the amorphous cracking component, prepared as disclosed above, is wetted with a solution of a compound of a selected metal, for example a compound of a metal selected from Groups 6, 8, 9 or 10 of the Periodic Table (new IUPAC notation), and more particularly a compound of a noble metal, such as hydrogen hexachloroplatinate(IV) [H₂PtCl₆]; chloroplatinic acid hexahydrate or hexachloroplatinate(IV) hexahydrate [H₂Cl₆Pt(H₂O)₄]; tetraamminoplatinum nitrate [Pt(NH₃)₄(NO₃)₂]; tetraamminoplatinum hydroxide [Pt(NH₃)₄(OH)₂]; or hexaammino platinum hydroxide [Pt(NH₃)₆(OH)₄], said impregnation being performed at room or close-to-room temperatures. After impregnation, the impregnated material is dried, preferably in air, at room or close-to-room temperature, and is submitted to calcination under an oxidizing atmosphere, preferably in air. Suitable temperatures for this calcination are from 200° C. to 600° C. The conditions are so adjusted that a noble metal is deposited on particles of the amorphous cracking component according to this invention, in an amount within the range of from 0.05 to 5% by weight, preferably of from 0.1 to 1%; more preferably of from 0.1 to 0.5%; or alternatively, a non-noble Group 8-10 metal (and optionally a Group 6 metal) is (are) deposited in an amount within the range of from 0.5 to 20% by weight, preferably of from 1 to 15%; more preferably of from 2 wt % to 15 wt %. When the hydro-dehydrogenation component comprises more than one metal such as a combination of a group 6 metal and at least one non-noble metal from Groups 8, 9, and 10 (typically Co—Mo, Ni—Mo, Ni—W, Co—W or Ni—Co—Mo combinations), the deposition of the metals can proceed by multiple impregnation steps, each impregnation step typically being followed by a drying step and optionally a calcination. The calcination step may not be necessary in between impregnation steps; and at least one calcination step is preferably performed after the last impregnation and drying cycle takes place.

Ion exchange comprises applying an aqueous solution of complexes comprising one or more catalytic metals, preferably a noble metal such as platinum and/or palladium, onto particles of the amorphous cracking component according to this invention, so as to incorporate the catalytic metal in the form of ions onto exchange sites present in the amorphous cracking component; draining the aqueous solution; and treating the drained particles. Methods for ion exchange are disclosed for example in U.S. Pat. Nos. 3,637,484 and 5,968,344, each of which is hereby incorporated in its entirety to the extent that they teach ion exchange and to the extent that their teachings are not contrary to the teachings of the present invention.

According to the deposition method based on ion exchange, the cracking component in the form of particles according to the present invention is suspended in a solution of a catalytic metal compound. The catalytic metal compound is preferably a water-soluble salt of a catalytic metal selected from Groups 6, 8, 9, and 10 of the Periodic Table. The catalytic metal preferably comprises a noble metal, particularly platinum and/or palladium. The solution of the catalytic metal compound preferably comprises a salt or complex of said noble metal, either in anhydrous form or in hydrate form, such as for non-limiting examples, hydrogen hexachloroplatinate(IV) [H₂PtCl₆] and in hydrate form: hexachloroplatinate(IV) hexahydrate [H₂Cl₆Pt(H₂O)₄], tetraamminoplatinum nitrate [Pt(NH₃)₄(NO₃)₂], tetraamminopalladium nitrate [Pd(NH₃)₄(NO₃)₂], tetraamminoplatinum hydroxide [Pt(NH₃)₄(OH)₂], hexaamminoplatinum hydroxide [Pt(NH₃)₆(OH)₄], by operating at room or close-to-room temperature, and at a pH value comprised within the range of from about 5.5 to about 10, preferably between about 5.5 and about 7. The use of complex hydroxides, nitrates or chlorides is advantageous in directing the exchange of the complex metal ions into the acidic sites associated with the support (i.e., comprising the cracking component of the present invention).

Another method of preparing the hydroprocessing catalyst by impregnating a catalyst material onto the amorphous inorganic oxide support of the present invention includes impregnating the support with a molten salt of a catalytic metal. Thus, another method includes preparing the supported metal catalyst from a molten metal salt. A compound of a second catalytic metal can be impregnated separately from a first catalytic metal. Alternatively, a compound of a second catalytic metal can be impregnated simultaneously with, e.g. in the same solution as, at least a portion of a first catalytic metal.

After the deposition step of the catalytic metal(s), the particles can then be separated from any utilized solution by means of filtration or decanting. The particles are typically washed with deionized water to form a hydroconversion catalyst precursor, which is then finally treated. The treatment can include drying the hydroconversion catalyst precursor. Drying preferably occurs at temperatures between about 80° C. and about 150° C., more preferably between about 110° C. and about 130° C. Typically, drying proceeds for from about 2 to about 16 hours at pressures between vacuum and about 60 psig (about 0-500 kPa), more preferably between about −2 psig and about 15 psig (about 90-200 kPa), more preferably at about atmospheric pressure, i.e., about −2 psig to 3 psig (about 90-120 kPa). Alternatively or after the drying step, treating the hydroconversion catalyst precursor includes calcination so as to form the hydroconversion catalyst. Calcining the hydroconversion catalyst precursor preferably occurs at temperatures between about 200° C. and about 600° C., more preferably between about 400° C. and about 600° C. Typically, calcination proceeds for from about 2 to about 6 hours at pressures between about −2 psig and about 15 psig (about 90-200 kPa), more preferably at about atmospheric pressure, i.e., about −2 psig to 3 psig (about 90-120 kPa).

In preferred embodiments, wherein the amorphous inorganic oxide support of the present invention comprises an amorphous silica-alumina, the conditions for the catalyst preparation are controlled so that an amount of a noble metal (typically Pt and/or Pd, preferably Pt) within the range of from 0.05 to 1% by weight, preferably of from 0.1 to 1%, more preferably of from 0.1 to 0.5%, is deposited on the silica-alumina particles according to the present invention.

The hydroconversion catalyst according to the present invention can be activated by drying and/or reduction, preferably by drying and subsequent reduction. These additional steps are preferably done as they tend to increase the selectivity characteristics of the hydroconversion catalyst. The drying can be carried out in an inert atmosphere or under a reducing atmosphere (such as with hydrogen) at a temperature comprised within the range of from 100° C. to 400° C. The reduction is obtained by means of the thermal treatment of the hydroconversion catalyst under a reducing atmosphere (i.e., with a reducing gas comprising mainly hydrogen; more than 80 vol. % H₂ is preferred) at temperatures comprised within the range of from 150° C. to 500° C.

The hydroconversion catalyst can be employed in a hydrocracking unit or a hydroisomerization unit, preferably in a hydrocracking unit. Hydrocracking is well known in the art and can occur at any suitable reactor conditions that achieve a desirable hydrocracked product. Hydrocracking typically takes place in a hydrocracker wherein a hydrocarbon feedstream and hydrogen are passed over a hydrocracking catalyst under suitable conversion promoting conditions so as to react some of the hydrocarbon components with hydrogen over the hydrocracking catalyst and to form the hydrocracked product. Since it is believed that the fraction of pore volume present in the micropores of the support affects the selectivity of the supported catalyst, preparing the hydrocracking catalyst of the present invention with a reduced micropore volume and/or with an increased mesopore volume fraction allows for improved selectivity towards middle distillate (especially towards diesel) rather than light C₁-C₄ hydrocarbons and thereby improved yield towards desirable hydrocarbon products.

The hydroconversion catalyst of the present invention comprising an amorphous, inorganic oxide support having a reduced micropore volume and/or an increased mesopore volume can be used as a hydrocracking catalyst to hydrocrack a liquid hydrocarbon feedstream from any process including conventional refinery processes, hydrocarbon synthesis processes, and the like to produce a hydrocracked product. The source of the liquid hydrocarbon feedstream is not critical for the present invention; however, in a preferred embodiment, the liquid hydrocarbon feedstream includes hydrocarbon products with at least 5 or more carbon atoms (C₅₊ hydrocarbons) generated in a hydrocarbon synthesis process. A preferred hydrocarbon synthesis process comprises a Fischer-Tropsch synthesis, which will be discussed in more detail in later paragraphs. More preferably, the hydrocarbon synthesis process comprises a low-temperature Fischer-Tropsch synthesis, such as employing a temperature between about 370° F. and about 500° F. (190° C.-260° C.) and a hydrocarbon synthesis catalyst comprising cobalt and/or ruthenium. The liquid hydrocarbon feedstream to the hydrocracking unit may further contain hydrocarbons from other sources, for example hydrocarbons from crude oil refining or from processing of shale oils and/or tar sands. For example, a Fischer-Tropsch product stream comprising C₅₊ hydrocarbon can be combined with one or more light boiling range fractions obtained from a distillation of crude oil and/or with one or more heavy boiling range fractions obtained from vacuum distillation, de-oiling and de-waxing processes or from processing of shale oils or tar sands, in order to form the liquid hydrocarbon feedstream to the hydrocracking unit.

The liquid hydrocarbon feedstream to the hydrocracking unit preferably comprises a hydrocarbon fraction from a hydrocarbon synthesis process such as employing the Fischer-Tropsch synthesis. The hydrocarbon fraction may be obtained by feeding a hydrocarbon synthesis product stream to a fractionator in order for its components to be separated based on their boiling point, so as to generate various hydrocarbon fractions of different boiling ranges, wherein at least one heavy fraction can be employed as feedstream to the hydrocracking unit. A heavy fraction suitable as feedstream to the hydrocracking unit preferably comprises mainly hydrocarbons with a boiling point equal to or greater than about 650° F. The liquid hydrocarbon feedstream to the hydrocracking unit preferably has a 5% boiling point equal to or greater than about 600° F. (representing hydrocarbons with about 20 or more carbon atoms or “C₂₀₊ hydrocarbons”). In alternate embodiments, the heavy fraction may have a boiling range comprising a 5% boiling point of about 800° F. (representing hydrocarbons with about 30 or more carbon atoms or “C₃₀₊ hydrocarbons”). The type of fractionator is not critical to the present invention and can comprise any fractionator technology and/or methods known in the art. One of ordinary skill in the art will readily understand the types of fractionators useful for separating liquid hydrocarbons of this nature into the various fractions described herein. For ease of discussion, and without any intention to be so limited, the fractionator can comprise a standard atmospheric fractional distillation apparatus, a short-path distillation unit and/or a vacuum distillation column, preferably at least an atmospheric distillation apparatus.

The hydroprocessing occurs under conditions suitable for hydrocracking the hydrocarbon synthesis product. Methods for hydrocracking are legion and well known in the art. The hydrocracking occurs in one or more reactors such as a fixed bed reactor, a trickle bed reactor, a catalytic distillation, or a fluidized reactor.

When the hydrocracking unit employs a hydrocarbon feedstock comprising primarily synthetic hydrocarbons derived from syngas conversion, the hydrocracking promoting conditions preferably include a temperature of about 500° F. to about 750° F. (260-400° C.); a pressure of about 500 psig to about 1,500 psig (3,550-10,440 kPa); an overall hydrogen consumption of 100-10,000 standard cubic feet per barrel of hydrocarbon feed (scf H₂/bbl HC) [about 17-1,800 STP m³H₂/m³ HC feed], preferably 100-2,000 scf H₂/bbl HC [about 17-350 STP m³H₂/m³ HC feed], more preferably 150-800 scf H₂/bbl HC [about 25-145 STP m³ H₂/m³ HC feed]; using a liquid hourly space velocity based on the hydrocarbon feedstock of about 0.1 to about 10 hr⁻¹, preferably between 0.25 to 5 hr⁻¹.

Under such conditions, the hydroconversion catalyst of the present invention hydrocracks hydrocarbons with a reduced selectivity towards gaseous hydrocarbons. More specifically, contacting the hydroconversion catalyst of the present invention with a hydrocarbon mixture comprising heavy paraffinic hydrocarbons produces a hydrocracked product. The hydrocracked product has typically less than 20 wt. % C₅₋ hydrocarbons, preferably less than 10 wt. % C₅₋ hydrocarbons. In addition, the hydroconversion catalyst of the present invention is characterized by a hexadecane selectivity index of less than 2.25, preferably less than 2, more preferably less than 1.8, still more preferably less than 1.6; wherein the hexadecane selectivity index represents the molar ratio of C₄ to C₁₂ hydrocarbons in the hydrocracked product when achieving about 40% hexadecane conversion.

In preferred embodiments, the liquid hydrocarbon feedstream to the hydroprocessing unit includes hydrocarbon products with at least 5 or more carbon atoms (C₅₊ hydrocarbons), preferably with at least 15 or more carbon atoms (C₅₊ hydrocarbons), more preferably with at least 20 or more carbon atoms (C₂₀₊ hydrocarbons), generated in a Fischer-Tropsch synthesis process. In a Fischer-Tropsch process, a syngas feed is fed to a hydrocarbon synthesis reactor. The syngas feed comprises hydrogen and carbon monoxide. It is preferred that the molar ratio of hydrogen to carbon monoxide in the syngas feed be greater than 0.5:1 (e.g., from about 0.67 to about 2.5). Preferably, when cobalt, nickel, iron, and/or ruthenium catalysts are used in the hydrocarbon synthesis reactor, the syngas feed comprises hydrogen and carbon monoxide in a molar ratio of about 1.4:1 to about 2.3:1, more preferably between about 1:7 to about 2.2:1. The syngas feed may also comprise carbon dioxide. Moreover, the syngas feed preferably comprises only a low concentration of compounds or elements that have a deleterious effect on the catalyst, such as poisons. For example, the syngas feed may be pretreated to ensure that it contains low concentrations of sulfur or nitrogen compounds such as hydrogen sulfide, hydrogen cyanide, ammonia and carbonyl sulfides. The syngas feed is contacted with the catalyst in a reaction zone. Mechanical arrangements of conventional design may be employed as the reaction zone including, for example, fixed bed, fluidized bed, slurry bubble column or ebullating bed reactors, among others. Accordingly, the preferred size and physical form of the catalyst particles may vary depending on the reactor in which they are to be used. Preferred embodiments include the use of a slurry bubble column reactor, wherein the slurry comprises catalyst particles and a hydrocarbon liquid, said particles being dispersed in said hydrocarbon liquid by the passing of a gas stream comprising gaseous reactants through said slurry. The catalyst particles preferably comprise cobalt and/or ruthenium as catalytic metal.

The hydrocarbon synthesis reactor is typically run in a continuous mode. In this mode, the gas hourly space velocity through the reaction zone typically may range from about 50 to about 10,000 hr⁻¹, preferably from about 300 hr⁻¹ to about 2,000 hr⁻¹. The gas hourly space velocity is defined as the volume of reactants per time per reaction zone volume. The volume of reactant gases is preferably at but not limited to standard conditions of pressure (101 kPa) and temperature (0° C.). The reaction zone volume is defined by the portion of the reaction vessel volume in which the reaction takes place and that is occupied by a gaseous phase comprising reactants, products and/or inerts; a liquid phase comprising liquid/wax products and/or other liquids; and a solid phase comprising catalyst. The reaction zone temperature is typically in the range from about 160° C. to about 300° C. Preferably, the reaction zone is operated at conversion promoting conditions at temperatures from about 190° C. to about 260° C., more preferably from about 205° C. to about 230° C. The reaction zone pressure is typically in the range of about 80 psia (552 kPa) to about 1,000 psia (6,895 kPa), more preferably from 80 psia (552 kPa) to about 800 psia (5,515 kPa), and still more preferably from about 140 psia (965 kPa) to about 750 psia (5,170 kPa). Most preferably, the reaction zone pressure is from about 250 psia (1,720 kPa) to about 650 psia (4,480 kPa).

The hydrocarbon synthesis reactor produces at least one hydrocarbon synthesis product, which primarily comprises hydrocarbons. The hydrocarbon synthesis product may also comprise oxygen-containing hydrocarbons, also called oxygenates, such as alcohols, aldehydes, esters, aldols, and the like. The hydrocarbon synthesis product preferably comprises primarily hydrocarbons with 5 or more carbons atoms.

A number of hydroprocessing steps can be applied to the hydrocarbon synthesis product stream or product fractions. Hydroprocessing involves passing the hydrocarbon synthesis product over the hydroprocessing catalysts of the present invention, which comprise the amorphous inorganic oxide supports having a reduced micropore volume. It is to be understood that such steps can occur in any order. For instance, the hydrocarbon synthesis product can be hydroprocessed before passing through a fractionator, or a hydrocarbon synthesis product fraction can be formed in a fractionator and then hydroprocessed. Preferably, a heavy fraction of the hydrocarbon synthesis product after being formed into a fractionator is hydrocracked employing a hydroconversion catalyst according to the present invention.

To further illustrate various illustrative embodiments of the present invention, the following examples are provided. It is understood that the examples are given by way of illustration and are not intended to limit the specification or the claims to follow in any manner.

### EXAMPLE 1

### Conventional Silica-Alumina Support

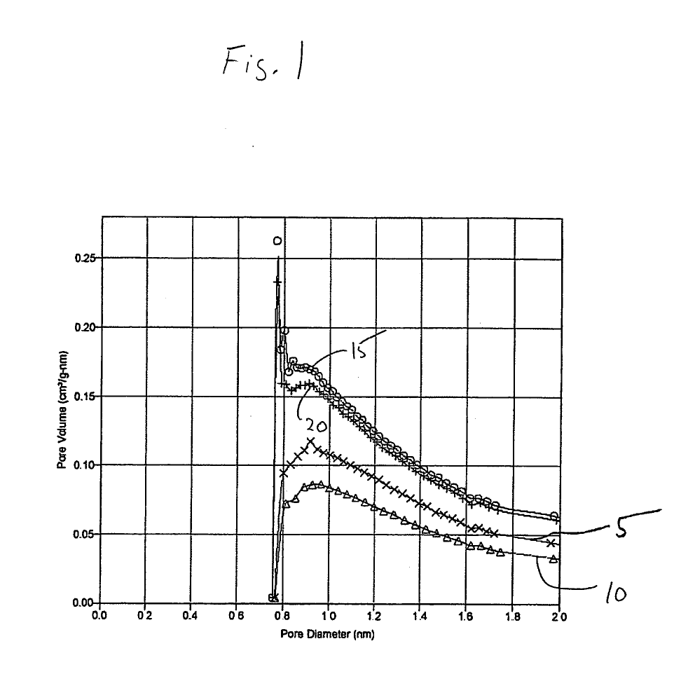

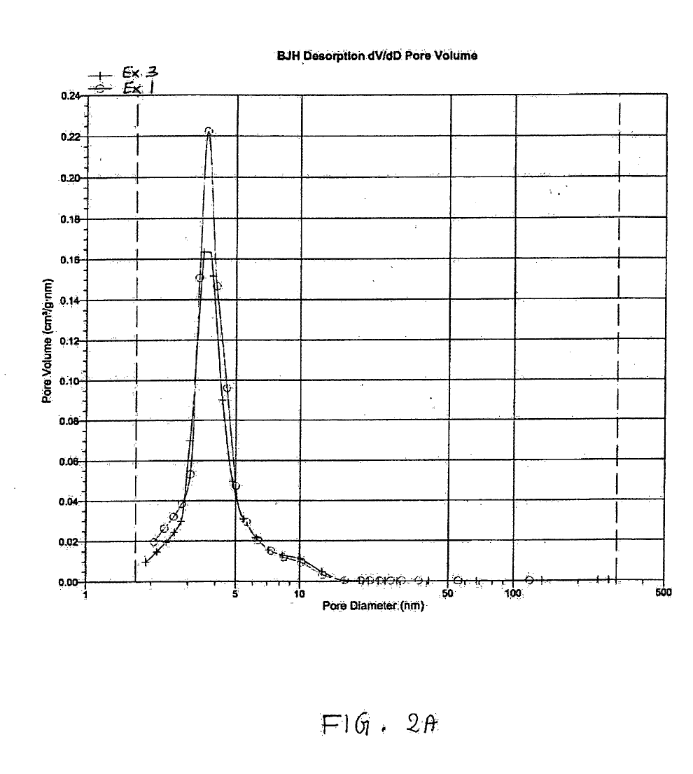

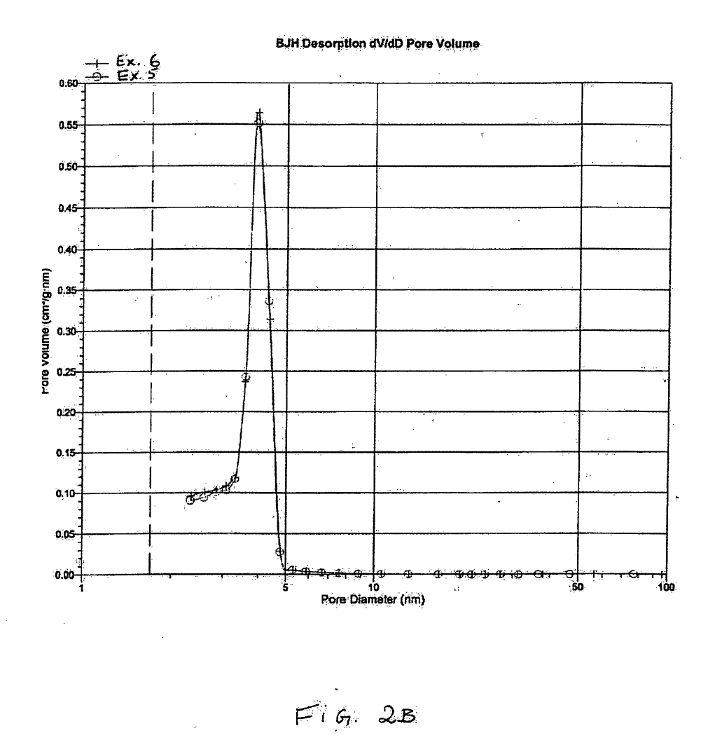

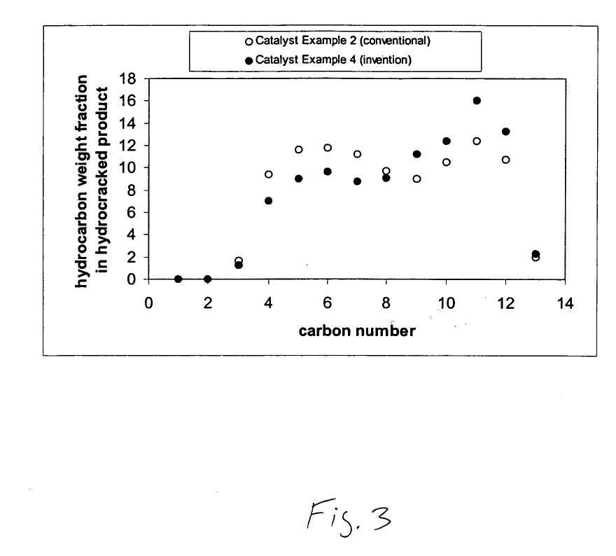

A silica-alumina support with a molar ratio of silica to alumina of 3:1 was prepared by co-precipitating sodium aluminate and sodium silicate (both from Aldrich) with the addition of diluted nitric acid. A hydrogel was obtained within 30 min, and the gelation pH was 10.5. The gel was then aged for three days at room temperature. Thereafter, ion exchange was performed with a 1.0 molar ammonium nitrate solution to convert it from the Na⁺ to H⁺ form. The hydrogel was washed with water to remove most of the ammonium nitrate. The gel was dried at 110° C. overnight and calcined in air at 550° C. for three hours. The resulting sample was then crushed and sieved to obtain particles of desired size (i.e., about 1.2 mm). The support had a BET surface area of 272 m²/g, a pore volume of 0.40 ml/g, and an average pore diameter of 4.0 nm. The micropore analysis of this support Example 1 is shown in the FIG. 1 as curve 5. A BJH desorption of Example 1 showing the mesopore distribution versus pore volume is shown in FIG. 2A.

### EXAMPLE 2

### Conventional Hydrocracking Catalyst

An incipient wetness impregnation of platinum was carried out by adding to the support of Example 1 a solution containing 0.2N hydrochloric acid in which the required amount of hydrogen hexachloroplatinate(IV) [H₂PtCl₆] was dissolved so as to achieve a platinum content of 0.5% Pt by weight of the total catalyst weight (after impregnation, drying and calcining). The catalyst was dried at 100° C. overnight and calcined at 500° C. for 3 hours.

### EXAMPLE 3

### Treatment of Support Example 1 with Silicic Acid

A sample of the support of Example 1 was impregnated with a two-step incipient wetness impregnation (also called pore volume impregnation) to add 4 wt. % silicic acid (with two applications of 2 wt. % silicic acid in water). The impregnated support was dried at 100° C. overnight after each impregnation and calcined at 500° C. for 3 hours. The micropore analysis of this support of Example 3 is shown in FIG. 1 as curve 10. A BJH desorption of Example 3 in FIG. 2A shows that the mean pore size of Example 3 (treated material) was about the same as for Example 1 (untreated material).

### EXAMPLE 4

### Catalyst (0.5% Pt/SiO₂₋Al₂O₃) Using the Support of Example 3

The impregnation of platinum on the support of Example 3 to make the catalyst of Example 4 was carried out in the same manner as described previously for the catalyst of Example 2.

### EXAMPLE 5

### Conventional Silica-Alumina Support

A silica-alumina support with a molar ratio of silica to alumina of 30:1 was prepared using the procedure of Example 1. The support had a BET surface area of 545 m²/g, a pore volume of 0.54 ml/g, and an average pore diameter of 4.0 nm. The micropore analysis of the support of Example 5 is shown in FIG. 1 as curve 15. A BJH desorption of Example 5 showing the mesopore distribution is shown in FIG. 2B.

### EXAMPLE 6

### Treatment of Support Example 5 with Silicic Acid

A sample of the support of EXAMPLE 5 was impregnated using a one-step incipient wetness impregnation (also called pore volume impregnation) to add 4 wt. % silicic acid (one application of 4 wt. % silicic acid in water). The impregnated support was dried at 100° C. overnight after the impregnation and calcined at 500° C. for 3 hours to form the support of Example 6. The micropore analysis of the support of Example 6 is shown in FIG. 1 as curve 20. A BJH desorption of the support of Example 6 in FIG. 2B shows that the mean pore size of Example 6 (treated material) is about the same as for Example 5 (untreated material).

### EXAMPLE 7

### Hydrocracking Catalyst Using the Support of Example 6

An incipient wetness impregnation of platinum (0.4% Pt/SiO₂) was carried out by adding to the support of Example 6 an aqueous solution containing 0.2 N hydrochloric acid in which the required amount of hydrogen hexachloroplatinate(IV) [H₂PtCl₆] was dissolved. The catalyst precursor (impregnated support) was dried at 100° C. overnight and calcined at 500° C. for 3 hours to form the catalyst of Example 7.

From FIG. 1, it can be seen that impregnation with silicic acid in the support of Example 3 and the support of Example 6 according to the present invention reduced the pore volume for pore diameters less than 1.5 nm (15 Å) by more than 5 percent. The reduction in micropore volume for micropores of size between 0.8 nm and 1.5 nm was estimated to be about 24% between curve 5 (unmodified material Example 1) and curve 10 (corresponding modified material Example 3), and about 7% between curve 15 (unmodified material Example 5) and curve 20 (corresponding modified material Example 6).

It can also be seen on FIGS. 2A and 2B that such impregnation of silicic acid also resulted in no substantial change in the pore distribution of Example 3 of the present invention (1.7% decrease) compared to that of unmodified Example 1 as well as no substantial change in the pore distribution of Example 6 of the present invention (3% increase) compared to that of unmodified Example 5.

### EXAMPLE 8

### Characterization by BJH Desorption

Surface area and pore size distribution were obtained for the supports of Examples 1, 3, 5 and 6 on a Micromeritics TriStar 3000 analyzer after degassing each sample at 190° C. in flowing nitrogen for five hours. Surface area can be determined from ten points in the nitrogen adsorption isotherm between 0.05 and 0.3 relative pressure and calculating the surface area by the standard BET procedure. Pore size distribution can be determined from a minimum of 30 points in the nitrogen desorption isotherm and calculated using the BJH model for cylindrical pores. The instrument control and calculations can be performed using the TriStar software and can be consistent with ASTM D3663-99 “Surface Area of Catalysts and Catalyst Carriers”, ASTM D4222-98 “Determination of Nitrogen Adsorption and Desorption Isotherms of Catalysts by Static Volumetric Measurements”, and ASTM D4641-94 “Calculation of Pore Size Distributions of Catalysts from Nitrogen Desorption Isotherms.” The initial surface area (A) of the support is the surface area of the catalyst structure prior to deposition of the catalytic metal. The pore volume (V) of the catalyst (N₂ as adsorptive) was measured and calculated using the method described above. Pore size (diameter) based on the same method was calculated as 4 V/A.

The BET surface area, BJH desorption pore volume and BJH desorption average pore diameter (measured using N₂ as adsorptive) for the supports of Examples 1, 3, 5 and 6 are given in Table 1.

TABLE 1

| | | | | | | Micropore |
|---|---|---|---|---|---|---|
| | Silica-to- | | | Mean | | volume |
| | alumina | | Pore | Pore | Mean pore | absolute |
| Support | molar | BET, | Vol., | size, | absolute | change |
| Ex. | ratio | m²/g | cc/g | nm | change, % | (0.8-1.5 nm), % |
| 1 | 3 | 272 | 0.40 | 5.88 | — | — |
| 3 | 3.2 | 249 | 0.36 | 5.78 | 1.7 | 24 |
| 5 | 30 | 545 | 0.54 | 3.96 | — | — |
| 6 | 31.3 | 519 | 0.53 | 4.08 | 3.0 | 7 |

The silica-to-alumina ratio of the modified supports of Examples 3 and 6 according to the present invention were slightly higher than that of the corresponding unmodified supports of Examples 1 and 5, as a result from the additional deposition of silicic acid by impregnation into pores and subsequent transformation from silicic acid to silica after treatment (calcination). The higher silica-to-alumina ratio (about 30:1 to 31:1) for Examples 5 and 6 resulted in a greater BET surface area, greater total pore volume and slightly smaller mean pore size, compared to those obtained for Examples 1 and 3 with silica-to-alumina ratio of about 3:1 to 3.2:1.

The BET surface area of the modified support of Example 3 according to the present invention (modified by two incipient wetness impregnations with 2% silicic acid) decreased about 8.5% compared to the unmodified support of Example 1, whereas the BET surface area of the modified support of Example 6 according to the present invention (modified by a single incipient wetness impregnation with 4% silicic acid) decreased about 4.8% compared to unmodified Example 5. Similarly, the pore volume of modified the support of Example 3 decreased about 10% compared to unmodified Example 1, whereas the pore volume of modified support Example 6 decreased by about 2% compared to unmodified Example 5. The mean pore size as shown in Table 1 changed only slightly after impregnation of silicic acid. A 1.7% decrease in mean pore size was observed for Example 3 modified with a two-step silicic acid impregnation compared to unmodified Example 1, whereas a 3% increase in mean pore size was observed for Example 6 modified with a one-step silicic acid impregnation compared to unmodified Example 5.

The micropore volume change measured from FIG. 1 and as shown in Table 1 was quite significant (24% reduction) for Example 3 according to the present invention compared to unmodified Example 1, while the total pore volume decreased by 10%, supporting that micropore filling was favored compared to mesopore filling. For a modification with a one-step impregnation of silicic acid, the micropore volume change was about a 7% reduction for Example 6 of the present invention compared to unmodified Example 5, while the total pore volume decreased by less than 2%, supporting again that micropore filling was favored compared to other pore filling.

Unmodified Example 5 had a greater micropore volume than that of unmodified Example 1. This difference in micropore volume may offer an explanation on the difference in reduction of micropore volume between the two sets of Examples (Ex. 1 & 3 versus Ex. 5 & 6). Since the same weight content of silicic acid (a total of 4 wt %) was applied to both supports of Example 1 and 5, one would expect that impregnating Example 5 comprising a greater micropore volume with silicic acid would require more silicic acid deposition and thus would not have resulted in the same percentage reduction in micropore volume. However, it is believed that the greater micropore volume reduction observed for Example 3 of the present invention can be explained by the reduced viscosity (less thickness) of the 2 wt % silicic acid applied in the two impregnation steps, compared to the higher viscosity of the 4 wt % silicic acid applied in one impregnation step for Example 6 of the present invention.

### EXAMPLE 9

### Performance Data

A sample of hydroprocessing catalyst Examples 2 and 4 made from unmodified support Example 1 and modified support Example 3 was used in a simulated hydrocracking of Fischer-Tropsch wax, which was carried out by hydrocracking normal hexadecane. In the procedure for the simulation, 10 g of catalyst was mixed with 60 g of 0.71 mm-0.60 mm glass beads (made of sodalime glass from Mo-Sci Corporation, Rolla, Mo.) and loaded into a tubular reactor (I.D. of about 2.1 cm and length of about 45 cm) with an axial thermowell (O.D of about 6.3 mm) running through the center of the tubular reactor. The catalyst loaded in the tubular reactor was brought up at a temperature of about 150° C. at atmospheric pressure under hydrogen for about 2 hours. The temperature was raised to 375° C., and the catalyst was reduced under a flow of hydrogen of 7.5 normal liters per hour (also at atmospheric pressure). The reactor was then cooled to reaction temperature (about 567-568° F. or about 297-298° C.), and the pressure in the tubular reactor was increased from atmospheric pressure to about 500 psig (3,550 kPa) under the mixed flow of hydrogen (180 scm³/min) and nitrogen (5 vol. %).

Hexadecane was added at a liquid flow rate of 0.22 ml/min using a HPLC pump, for a hydrogen-to-hexadecane feed molar ratio of about 11.9:1. The product was collected in a two stage knock-out system with the residual tail gas being analyzed on-line. The liquid products were analyzed off-line. Table 2 illustrates the catalyst run conditions. The results on the mole fraction of hydrocarbons in hydrocracked product versus carbon number (from 1 to 16) of hydrocarbons, one the weight percent of cracked products from hexadecane versus carbon number (from 1 to 16) of cracked products, the percent hexadecane conversion and hexadecane selectivity index for catalyst Examples 2 and 4 are shown in Tables 3, 4 and 5.

TABLE 2

| | Catalyst Ex. | |
|---|---|---|
| | Example 2 | Example 4 |
| Composition | 0.5 wt % Pt | 0.5 wt % Pt |
| | on support Ex. 1 | on support Ex. 3 |
| Catalyst Weight, g | 10 | 10 |
| Reactor Temperature ° F. | 568 | 567 |
| Reactor Temperature ° C. | 298 | 297 |
| Pressure, psig | 500 | 500 |
| WHSV, /hr | 1.02 | 1.02 |
| H₂/Hexadecane, mol/mol | 11.9 | 11.9 |

TABLE 3

| | |
|---|---|
| | Mole fraction of hydrocarbon |
| Carbon | in hydrocracked product |

| Number | Example 2 | Example 4 |
|---|---|---|
| C₁ | 0 | 0 |
| C₂ | 0 | 0 |
| C₃ | 0.020 | 0.016 |
| C₄ | 0.085 | 0.070 |
| C₅ | 0.085 | 0.072 |
| C₆ | 0.072 | 0.065 |
| C₇ | 0.059 | 0.051 |
| C₈ | 0.045 | 0.046 |
| C₉ | 0.037 | 0.051 |
| C₁₀ | 0.039 | 0.050 |
| C₁₁ | 0.042 | 0.059 |
| C₁₂ | 0.033 | 0.045 |
| C₁₃ | 0.0057 | 0.007 |
| C₁₄ | 0 | 0 |
| C₁₅ | 0 | 0 |
| C₁₆ | 0.474 | 0.46 |

TABLE 4

| | |
|---|---|
| | Wt % of cracked products from hexadecane |
| Carbon | in hydrocracked product |

| Number | Example 2 Catalyst | Example 4 Catalyst |
|---|---|---|
| 1 | 0 | 0 |
| 2 | 0 | 0 |
| 3 | 1.67 | 1.23 |
| 4 | 9.37 | 7.04 |
| 5 | 11.6 | 8.97 |
| 6 | 11.8 | 9.64 |
| 7 | 11.2 | 8.79 |
| 8 | 9.75 | 9.08 |
| 9 | 9.00 | 11.3 |
| 10 | 10.5 | 12.4 |
| 11 | 12.4 | 16.0 |
| 12 | 10.7 | 13.3 |
| 13 | 1.99 | 2.32 |

TABLE 5

| | Example 2 | Example 4 |
|---|---|---|
| | Catalyst | Catalyst |
| Reactor Temperature ° C. | 298 | 297 |
| Conversion % | 40 | 39 |
| C₄/C₁₂ | 2.58 | 1.55 |

An indication of the improved selectivity of the catalyst of Example 4 of the present invention was its lower hexadecane selectivity index (as defined as the C₄/Cl₂ molar ratio in the hydrocracked product at about 40% conversion when using n-hexadecane as feedstock) of about 1.55, compound to the hexadecane selectivity index (2.58) of the conventional catalyst of Example 2, as shown in Table 5. The lower hexadecane selectivity index of Example 4 indicated a better selectivity towards a more desirable hydrocracked product.

Hence, from the results in Tables 3-5, it can be seen that the hydroprocessing catalyst of Example 4 supported on the modified silica-alumina support of Example 3 (impregnated with silicic acid) according to the present invention had a lower selectivity towards gaseous hydrocarbons (i.e. C₅₋hydrocarbons) than the catalyst of Example 2.

Although the present invention and its advantages have been described in detail, it should be understood that various changes, substitutions and alterations may be made herein without departing from the spirit and scope of the invention as defined by the appended claims.

1. A method for reducing a volume of micropores in an amorphous material, comprising:
(A) providing an amorphous material having a volume of micropores, wherein the amorphous material comprises a mean pore diameter; and
(B) depositing an inorganic oxide or an inorganic oxide precursor to the amorphous material; and
(C) treating said deposited amorphous material to form a modified amorphous material such that the modified amorphous material has a micropore volume at least 5 percent lower than that of the provided amorphous material, and wherein the modified amorphous material has a mean pore diameter differing by not more than 10 percent from that of the provided amorphous material.

2. The method of claim 1, wherein the amorphous material comprises an amorphous inorganic oxide.

3. The method of claim 1, wherein the amorphous material comprises at least one material selected from the group consisting of titania, silica, alumina, zirconia, silica-alumina, silica-titania, alumina-titania, and any mixture of two or more thereof.

4. The method of claim 1, wherein the amorphous material comprises silica-alumina.

5. The method of claim 1, wherein the micropore volume is reduced by at least 10%.

6. The method of claim 1, wherein the micropore volume is reduced by at least 20%.

7. The method of claim 1, wherein the mean pore diameter of the provided amorphous material is at least 2 nm.

8. The method of claim 7, wherein the mean pore diameter of the provided amorphous material is between about 2 nm and 12 nm.

9. The method of claim 8, wherein the mean pore diameter of the provided amorphous material is between about 3 nm and 9 nm.

10. The method of claim 1, wherein the mean pore diameter is reduced by not more than 5%.

11. The method of claim 1, wherein the mean pore diameter is reduced by not more than 3%.

12. The method of claim 1, wherein the inorganic oxide or the inorganic oxide precursor comprises at least one element selected from the group consisting of silicon, aluminum, titanium, zirconium, vanadium, yttrium, cerium, thorium, and tungsten.

13. The method of claim 12, wherein the inorganic oxide comprises an oxide of silicon.

14. The method of claim 12, wherein the inorganic oxide precursor comprises a silicon-containing compound.

15. The method of claim 13, wherein the inorganic oxide precursor comprises silicic acid.

16. The method of claim 1, wherein step (B) is accomplished by impregnating a colloidal sol to the provided amorphous material, wherein the colloidal sol comprises the inorganic oxide or the inorganic oxide precursor.

17. The method of claim 16, wherein the colloidal sol comprises silicic acid.

18. The method of claim 1, wherein treating comprises calcining at a temperature between about 400° C. and about 600° C.

19. The method of claim 18, wherein treating further comprises drying the amorphous material at a temperature between about 80° C. and about 120° C. prior to calcination.

20. A method for making a hydroprocessing catalyst characterized by a low selectivity towards gaseous hydrocarbons, comprising:
(A) providing an amorphous inorganic oxide material, wherein the amorphous inorganic oxide material comprises a volume of micropores, and wherein the amorphous inorganic oxide material further comprises a mean pore diameter;
(B) depositing an inorganic oxide or an inorganic oxide precursor to the amorphous inorganic oxide material;
(C) treating said deposited amorphous inorganic oxide material to form an amorphous support such that the amorphous support has a micropore volume at least 5 percent lower than that of the amorphous material and the amorphous support has a mean pore diameter differing by not more than 10 percent from that of the amorphous material;
(D) depositing a compound of a catalytic metal to the amorphous support; and
(E) treating the amorphous support comprising the deposited catalytic metal compound so as to form the catalyst.

21. The method of claim 20, wherein the amorphous inorganic oxide material comprises at least one material selected from the group consisting of titania, silica, alumina, zirconia, silica-alumina, silica-titania, alumina-titania, and any mixture of two or more thereof.

22. The method of claim 20, wherein the amorphous inorganic oxide material comprises silica-alumina.

23. The method of claim 20, wherein the micropore volume is reduced by at least 10%.

24. The method of claim 20, wherein the micropore volume is reduced by at least about 20%.

25. The method of claim 20, wherein the mean pore diameter is reduced by not more than about 5%.

26. The method of claim 20, wherein the mean pore diameter is reduced by not more than about 3%.

27. The method of claim 20, wherein the deposited inorganic oxide or the deposited inorganic oxide precursor comprises at least one element selected from the group consisting of silicon, aluminum, titanium, zirconium, vanadium, yttrium, cerium, thorium, tungsten, and any mixture of two or more thereof.

28. The method of claim 20, wherein the deposited inorganic oxide comprises silicon.

29. The method of claim 28, wherein the deposited inorganic oxide comprises an oxide of silicon.

30. The method of claim 28, wherein the deposited inorganic oxide precursor comprises silicon.

31. The method of claim 20, wherein step (B) is accomplished by impregnating a colloidal sol to the amorphous inorganic oxide material, wherein the colloidal sol comprises the inorganic oxide or the inorganic oxide precursor.

32. The method of claim 31, wherein the amorphous support comprises silica-alumina.

33. The method of claim 32, wherein the colloidal sol comprises silicic acid.

34. The method of claim 20, wherein step (C) comprises drying at a temperature between about 80° C. and about 150° C.

35. The method of claim 20, wherein step (C) comprises calcining at a temperature between about 400° C. and about 600° C.

36. The method of claim 20, wherein the catalytic metal comprises at least one metal selected from the group consisting of platinum, palladium, nickel, cobalt, tungsten, and molybdenum.

37. The method of claim 20, wherein the catalytic metal comprises at least one metal selected from the group consisting of platinum and palladium.

38. The method of claim 20, wherein the hydroprocessing catalyst is suitable for hydroprocessing a hydrocarbon product of a hydrocarbon synthesis process.

39. The method of claim 38, wherein the hydrocarbon synthesis process is a Fischer-Tropsch process.

40. A method for hydrocracking hydrocarbons with improved selectivity towards desirable products, comprising:
(A) providing a hydrocracking catalyst comprising a dehydro-hydrogenation component deposited on a modified porous amorphous support, wherein the modified porous amorphous support was made by a method comprising depositing a selective micropore filling agent to an amorphous material comprising pores of various pore sizes, including micropores with pore size of less than 1.5 nm, and treating the deposited amorphous material so as to form the modified porous amorphous support, wherein the volume fraction of micropores in the modified amorphous support is lower by at least about 5% than that of the amorphous material, and further wherein the mean pore size of the modified amorphous support differs by not more than about 10% from that of amorphous material; and
(B) reacting a hydrocarbon stream with hydrogen over said hydrocracking catalyst under conversion promoting conditions so as to form a hydrocracked product.

41. The method of claim 40, wherein the dehydro-hydrogenation component comprises at least one metal selected from the group consisting of platinum, palladium, nickel, cobalt, tungsten, and molybdenum.

42. The method of claim 40, wherein the dehydro-hydrogenation component comprises at least one metal selected from the group consisting of platinum and palladium.

43. The method of claim 40, wherein the modified porous amorphous support comprises an amorphous inorganic oxide.

44. The method of claim 40, wherein the modified porous amorphous support comprises at least one material selected from the group consisting of titania, silica, alumina, zirconia, silica-alumina, silica-titania, alumina-titania, and any mixture of two or more thereof.

45. The method of claim 44, wherein the modified porous amorphous support comprises silica-alumina.

46. The method of claim 45, wherein the silica-alumina comprises a silica-to-alumina molar ratio between 3:1 and 500:1.

47. The method of claim 40, wherein the modified porous amorphous support comprises a mean pore size between about 2 nm and 12 nm.

48. A method for hydrocracking hydrocarbons with reduced secondary cracking towards gaseous hydrocarbon products, comprising:
(A) providing a hydrocracking catalyst, wherein the hydrocracking catalyst comprises a dehydro-hydrogenation component deposited on a porous amorphous silica-alumina support comprising a wide range distribution of pore sizes and a mean pore size between about 2 nm and 12 nm, and wherein the hydrocracking catalyst is characterized by a hexadecane selectivity index of less than 2.25; and
(B) reacting a hydrocarbon stream with hydrogen over the hydrocracking catalyst under conversion promoting conditions so as to form a hydrocracked product.

49. The method of claim 48, wherein the hexadecane selectivity index is less than 2.0.

50. The method of claim 48, wherein the hexadecane selectivity index is less than 1.8.

51. The method of claim 48, wherein the porous amorphous support comprises silica-alumina.

52. The method of claim 48, wherein the porous amorphous support comprises a mean pore size between about 3 nm and 9 nm.
